(19) United States
(12) Patent Application Publication
(10) Pub. No.: US 2010/0272929 A1
(43) Pub. Date: Oct. 28, 2010

(54) LABELS

(75) Inventor: Fiona MacIntyre, Cumbria (GB)

Correspondence Address: McKeon Meunier Carlin & Curfman LLC, 817 W. Peachtree Street, Suite 900, Atlanta, GA, 30308, US

(73) Assignee: INNOVIA FILMS LIMITED, Cumbria (GB)

(21) Appl. No.: 12/519,680

(22) PCT Filed: Dec. 17, 2007
(86) PCT No.: PCT/GB2007/050762

§ 371 Date: Aug. 20, 2009

(30) Foreign Application Priority Data
Dec. 18, 2006 (GB) 0625171.4
Jan. 24, 2007 (GB) 0701339.4
Aug. 23, 2007 (GB) 0716453.6

(51) Int. Cl. B41M 5/40

(52) U.S. Cl. 428/32.18; 428/32.22; 428/32.38

(57) ABSTRACT

An inherently ink printable multi-layer label stock film having a substrate core layer comprising a polymeric material and at least one skin layer which is ink printable, the ink printable skin layer comprising a copolymer of styrene and butadiene and polystyrene in an amount of from 0% to about 30% by weight of the skin layer.

The present invention relates to an inherently printable labelstock film having good ink adhesion properties, and relates more particularly to an improved inherently printable film having good ink adhesion properties in the absence of any topcoat to the film, and to labels made therefrom.

In recent years, diversification of printed products has required printing on a wide variety of materials in sheets; for example papers, synthetic papers, polymer films such as thermoplastic resin films, metallic foils, metallised sheets, etc. These printed items are printed by methods such as offset printing, gravure, flexography, screen press printing and letter press printing. Commonly, inkjet printing is now used to print directly onto the surface of various types of polymer film, such as polyester film for example.

This invention is particularly concerned with polyolefinic films for use in label and certain graphic arts applications, but may also utilise substrates other than polyolefinic films. It is believed however that polyolefinic films may provide an environmentally friendly alternative to PVC films which are commonly used in labels and graphic arts applications at present.

Uncoated PVC film has been used as a film substrate for printing but has other disadvantages as a substrate for applications such as graphic arts or labels. However, many non-PVC films are not very receptive to common inks such as solvent based inks, used for example in inkjet printing and UV inks, used for example in flexo and screen printing. For this reason non-PVC films, such as polyolefin films for example, are commonly provided with a topcoat to assist ink printability. It would however be desirable to provide an inherently printable non-PVC film substrate, such as a polyolefinic film substrate (e.g. a polyethylene or polypropylene film substrate) to be used without any topcoat and which provides some or all of those properties desired in an ink printable surface.

Due to the constraints imposed on the ink characteristics due to the nature of the various printing processes, such as flexo, screen and inkjet processes, this latter whether in a thermal or piezo inkjet printer, it is preferable that ink receiving surface of the substrate is modified rather than the ink itself to optimise some or all of the desired properties in the final printed image.

Some of the criteria that an ideal ink receptive substrate will possess include some or all of the following, depending on the particular application (e.g. for a ‘no-label’ look transparency is important rather than whiteness or opacity). A suitable ink printable substrate will have good optical properties such as brightness, whiteness, gloss, opacity and/or colour range to give high-quality images. The substrate should be compatible with components in the ink to ensure that the final ink image has sufficient fastness and low tendency to fade, for example when exposed to UV light. The absorbency of the film surface is important. Some printing processes place special demands on the substrate which is printed with a large amount of liquid, and yet is expected to dry quickly without changing size or shape. Although paper fibres absorb liquid well, they swell and deform resulting in surface imperfections and such moisture-induced undulations have a detrimental effect on image quality. Paper is also unsuitable for many applications as described herein. A suitable substrate will be durable, in that it will maintain its structure for the time of the print. Desirable properties of such a film therefore include dimensional stability, tear resistance, thermal stability, and water and light resistance. Thus to produce a good image the ink receiving surface should be dimensionally and thermally stable, i.e. it should not tear, stretch or deform, and it should be smooth and waterproof, maintain its shape and be resistant to many chemicals, and should not swell or shrink with moisture or humidity to an unacceptable degree. Further desirable properties include that co-extruded layers should not delaminate. This is particularly important when forming biaxially orientated layers using the so called bubble process.

EP 0262228 discloses a transparent plastic printing film which is provided with a top coating of an ink setting layer formed of a solution of a rubber resin and/or styrene resin and silica sol.

JP 2004195744 discloses a printing medium which comprises a compounded resin layer of a styrene-ethylene-propylene-styrene block copolymer and an ethylenic copolymer.

US 2005/0142372 discloses a biaxially orientated multilayer film having a polyolefinic core layer and a skin layer containing a styrene-butadiene copolymer or a cyclic olefin copolymer.

US 2004/0137206 discloses a packaging film including a first layer elastomer, a second layer of polyolefin in contact with the first layer and a third layer of elastomer in contact with the second layer.

U.S. Pat. No. 6,783,864 discloses a film comprising two outer layers consisting of a mixture of styrene homopolymers and styrene-butadiene-styrene block copolymers and a core polyolefin layer.

It is an object of the invention to provide a polymer labelstock film having an improved inherently ink printable surface. It is a further object of the invention to overcome some of the problems described herein to provide a labelstock film substrate which is printable by printing methods such as flexo, screen and inkjet printing, for example by providing a substrate suitable for inherent printability in the absence of any topcoat layer.

According to the present invention there is provided an inherently ink printable multi-layer facestock film for labels having a substrate core layer comprising a polymeric material and at least one skin layer which is ink printable, the ink printable skin layer comprising a copolymer of styrene and butadiene, and polystyrene in an amount of from 0% to about 30% by weight of the skin layer.

The skin layer has a thickness of from 0.1 μm to 0.5 μm, and we have surprisingly found that good inherent ink printability can be achieved with skin layer thicknesses in this range.

Also provided in accordance with the invention is an adhesive containing labelstock for use in adhesive labels which comprises: a multilayer film facestock as hereinbefore described and an adhesive layer provided on the facestock.

In the labelstock film of the invention, the adhesive layer may be a pressure-sensitive adhesive layer.

The labelstock film of the invention may further comprise a release coated liner in contact with and releasably joined to the adhesive layer.

The invention also provides a label made from the aforesaid facestock, and an adhesive label die-cut from the aforesaid labelstock.

We have found that multi-layer films for labelstock application with improved printability on a skin layer thereof can be realised by the use of a copolymer of styrene and butadiene in the said skin layer. Preferably the copolymer is a block copolymer of styrene and butadiene. The copolymer may in some cases be blended with other materials in the skin layer. However, if the copolymer is blended with a styrenic homopolymer, we have found that it is necessary for any such homopolymer to be present in the skin layer in an amount (if present at all) of less than about 30% by weight of the skin layer in order to maintain satisfactory printability and/or ink adherence on the film. When present, the styrenic homopolymers are provided in the skin layer preferably in an amount of less than 20% by weight of the coating, more preferably of less than 17.5% by weight of the coating, still more preferably less than about 15% by weight of the coating and most preferably less than about 10% by weight of the coating. In one embodiment of the invention the skin layer comprises no styrenic homopolymer, or substantially no styrenic homopolymer. Without wishing to be bound by any such theory, it is thought likely that the amorphous nature of the copolymer in the skin layer provides a satisfactory medium for ink penetration and adherence, and that such amorphousness may be compromised by too high a quantity of styrenic homopolymer in the skin layer composition.

The copolymeric skin layer has been found satisfactorily to adhere to the substrate layer, and is generally coextruded onto the substrate layer, with no insurmountable problems being encountered with regard to adherence of the skin layer and the substrate layer. Nevertheless, in some cases it may be desirable to increase the degree of adherence between these layers, in which case the multi-layer film may comprise at least one tie constituent having compatibility with the polymeric material of the core layer and with the skin layer, the said compatibility of the tie constituent deterring delamination of the skin layer from the core layer. By “compatibility” is preferably meant that the tie constituent has an affinity, for example a chemical affinity, both for material of the skin layer and for material of the core layer.

The tie constituent, when present, may be provided in a tie layer of the film between the core layer and the at least one skin layer. Alternatively (or as well), the tie constituent may be provided in the core layer. Alternatively (or as well) the tie constituent may be provided in the skin layer. The tie constituent when present preferably comprises a derivative of styrene-butadiene, for example hydrogenated styrene-butadiene.

The layers of the film are preferably coextruded, or provided by melt coat extrusion of the at least one skin layer onto the core layer or onto any further coating or extruded layer provided on the core layer.

Thus, according to one aspect of the present invention there is provided an inherently ink printable multi-layer facestock film for labels having a substrate core layer and at least one skin layer which is ink printable, the ink printable skin layer comprising a copolymer of styrene and butadiene, the substrate core layer and the skin layer being coextruded to form the multi-layer film.

By “ink printable” is generally meant that in a standard ink pull-off tape test or UV flexo tests conducted on a film according to the invention which has been printed on its skin layer with a compatible ink and then cured (for example UV cured) and allowed to age for 24 hrs before testing, less than 50%, preferably less than 40%, more preferably less than 30%, still more preferably less than 20% and most preferably less than 10% of the ink is removed from the printed surface in the test. In a particularly preferred embodiment of the invention, less than 5%, or even as low as substantially 0%, of the ink is removed in such testing.

Also by “ink printable” is generally meant that in a standard ink pull-off tape test or UV flexo tests conducted on a film according to the invention which has been printed on its skin layer with a compatible ink and then tested immediately thereafter, less than 75%, preferably less than 60%, more preferably less than 50%, still more preferably less than 40% and most preferably less than 30% of the ink is removed from the printed surface in the test. In a particularly preferred embodiment of the invention, less than 20%, or even below 10%, of the ink is removed in such testing.

Also provided in accordance with the present invention is a polymer labelstock film in accordance with the above printed on its skin layer with at least one ink.

The invention also provides a process for ink printing comprising providing a film in accordance with the above and supplying to the skin layer of the film by means of screen, flexo, inkjet or other printing means, at least one compatible ink.

The core layer of the film may comprise additional materials such as anti-block additives, opacifiers, fillers, UV absorbers, cross-linkers, colourants, anti-static agents, antioxidants, slip additives and the like.

The tie layer of the film, when present, may comprise additional materials such as anti-block additives, opacifiers, fillers, UV absorbers, cross-linkers, colourants, anti-static agents, antioxidants, slip additives and the like.

The skin layer of the film may comprise additional materials such as anti-block additives, opacifiers, fillers, UV absorbers, cross-linkers, colourants, anti-static agents, antioxidants, slip additives and the like.

The film of the invention may be further treated, by corona discharge treating for example, further to improve ink receptivity of the film.

The polymeric film can be made by any process known in the art, including, but not limited to, cast sheet, cast film, or blown film. The film core substrate may comprise a polyolefin film, for example polyethylene, polypropylene, mixtures thereof, and/or other known polyolefins.

This invention may be particularly applicable to films comprising cavitated or non-cavitated polypropylene films, with a polypropylene core and skin layers with a thickness substantially below that of the core layer. The film may have additional layers around the core layer, for example comprising copolymers of ethylene and propylene or terpolymers of propylene, ethylene and butylene. The film may comprise a biaxially orientated polypropylene (BOPP) film, which may be prepared as balanced films using substantially equal machine direction and transverse direction stretch ratios, or can be unbalanced, where the film is significantly more orientated in one direction (MD or TD). Sequential stretching can be used, in which heated rollers effect stretching of the film in the machine direction and a stenter oven is thereafter used to effect stretching in the transverse direction. Alternatively, simultaneous stretching, for example, using the so-called bubble process, or simultaneous draw stenter stretching may be used.

Alternatively, the film core substrate may comprise a polyester film, a polyamide film, a polyurethane film, a polyvinylhalide film or an acetate film.

The surface of the film has improved ink adhesion properties in relation to a film manufactured from polyolefin materials in the same or similar manner as the film of the invention, but without an effective amount of styrene-butadiene in the skin layer.

The films used in accordance with the present invention can be of a variety of thicknesses according to the application requirements. For example they can be from about 10 to about 240 μm thick and preferably from about 50 to about 90 μm thick.

In a multi-layer film in accordance with the invention having at least a substrate core layer and a skin layer, the skin layer is ink printable and comprises a copolymer of styrene and butadiene making the skin layer surface ink printable. The skin layer preferably has a thickness of from about 0.1 μm to about 0.5 μm.

The invention will now be more particularly described with reference to the following examples.

### EXAMPLE 1

The compositions of this Example were prepared and tested on a bubble blown coextruded film of conventional clear BOPP film of 58 μm thickness and 22.0 m² kg⁻¹ yield (corona discharge treated on the side to be printed) available commercially from Innovia Films Ltd under the trade mark Rayoface C58, with and without EVA (comparative) and styrene-butadiene (in accordance with the invention) added to, or constituting, the coextruded skin layer.

EVA (ethylene/vinyl acetate copolymer) is available under the trade name Evatane from Arkema.

Styrene Butadiene copolymer is commercially available as K-Resin DK11NW supplied by Chevron Phillips.

The Dyne level of each sample was measured and printing on the samples was then effected using a handheld UV flexo printing technique. The ink selected for testing purposes was W300 Paragon White, which was cured with a double pass at 60 ft/s and 200 Watts/inch.

The printed samples were then investigated for ink adhesion properties by a standard ink pull-off tape test. This technique involves applying a 10 cm length of Scapa tape to the surface of the printed film using a standard weighted hand-roller. The adhesive tape is subsequently pulled-off from the substrate at an approximate angle of 135° at speed and the percentage ink pull-off determined by the tester. In addition Lab based UV flexo experiments have confirmed the ink pull-off values of <5 and 0 for the 100% K-RESIN film tested immediately post cure and 24 hours post cure respectively. Solvent based gravure printing also achieved the same results.

The results are presented in Table 1:

TABLE 1

| | Dyne | Ink pull-off % | Ink pull-off % |
|---|---|---|---|
| Sample | Level | at 0 hours | at 24 hours |
| C58 | 44 | 95 | 95 |
| C58 + 20% EVA | 46 | 95 | 90 |
| C58 + 40% EVA | 46 | 80 | 10 |
| C58 + 100% K- | 54 | <5 | 0 |
| Resin | | | |

These result demonstrated the improved ink adhesion properties of the films of the invention.

The present invention therefore provides an improved inherently ink printable surface.

### EXAMPLE 2

The compositions of Example 1 are prepared and tested on a bubble blown coextruded film, but with a tie layer formed of commercially available hydrogenated styrene-butadiene rubber supplied as Tuftec™ by Asahi.

Similar results are obtained but the coextruded film is envisaged in some respects to be more robust with less tendency for the skin layer to peel off (i.e. delaminate) under harsh test conditions.

### EXAMPLE 3

The compositions of this example were prepared and tested on a bubble blown coextruded film, but with the outer skin layer comprising various blends of K-Resin with polystyrene (Table 2). The polystyrene is the commercially available grade GPPS 145D by BASF.

Blending of K-Resin with polystyrene is carried out on a Francis Shaw twin screw extruder.

TABLE 2

| Skin layer | Dyne level | Ink pull-off % | Ink Pull-off % |
|---|---|---|---|
| blend | post-treat | at 0 hrs | at 24 hrs |
| K-R/PS | 54 | <5 | 0 |
| 100%/0% | | | |
| K-R/PS | 54 | <5 | 0 |
| 95%/5% | | | |
| K-R/PS | 52 | 10 | 5 |
| 90%/10% | | | |
| K-R/PS | 52 | 10 | 5 |
| 85%/15% | | | |
| K-R/PS | 52 | 15 | 10 |
| 80%/20% | | | |
| K-R/PS | 50 | 15 | 10 |
| 75%/25% | | | |
| K-R/PS | 50 | 30 | 20 |
| 65%/35% | | | |

The data from Table 2 shows a decrease in ink adhesion performance as the level of polystyrene in the skin layer blend is increased.

### EXAMPLE 4

The compositions of this example were prepared and tested on a bubble blown coextruded film, but with the outer skin layer comprising various blends of K-Resin with polystyrene (Table 3). The polystyrene is the commercially available grade GPPS 145D by BASF.

Blending of K-Resin with polystyrene is carried out on a Francis Shaw twin screw extruder.

TABLE 3

| Skin layer | Dyne Level | Ink pull-off % | Ink pull-off % |
|---|---|---|---|
| blend | post-treat | at 0 hrs | at 24 hrs |
| K-R/PS | 54 | <5 | 0 |
| 100%/0% | | | |
| K-R/PS | 52 | <5 | 0 |
| 95%/5% | | | |
| K-R/PS | 52 | 5 | 5 |
| 90%/10% | | | |
| K-R/PS | 50 | 20 | 30 |
| 85%/15% | | | |
| K-R/PS | 48 | 30 | 30 |
| 80%/20% | | | |
| K-R/PS | 46 | 15 | 25 |
| 75%/25% | | | |
| K-R/PS | 40 | 40 | 35 |
| 65%/35% | | | |

The data from Table 3 shows a decrease in ink adhesion performance as the level of polystyrene in the skin layer blend is increased.

### EXAMPLE 5

The composition of this example was prepared and tested on bubble produced cast tube which was externally melt coat extruded and then biaxially stretched to form a film. The outer skin layer comprised of K-Resin (Table 4).

TABLE 4

| Melt coat extruded | Ink pull-off % | Ink pull-off % |
|---|---|---|
| Skin layer | at 0 hrs | at 24 hrs |
| K-Resin | <5 | <5 |

The data from Table 4 demonstrated the improved ink adhesion properties of the melt coat extruded films of the invention.

1-27. (canceled)

28. An inherently ink printable multi-layer facestock film for labels having a substrate core layer comprising a polymeric material and at least one skin layer which is ink printable, the ink printable skin layer comprising: a copolymer of styrene and butadiene; and polystyrene in an amount of from 0% to about 30% by weight of the skin layer.

29. A label facestock film according to claim 28, wherein the ink printable skin layer has a thickness of from 0.1 μm to 0.5 μm.

30. A label facestock film according to claim 28, wherein the ink printable skin layer comprises from 0% by weight to less than 20% by weight of polystyrene.

31. A label facestock film according to claim 28, wherein the copolymer is a block copolymer of styrene and butadiene.

32. A label facestock film according to claim 28, comprising substantially no styrenic homopolymer.

33. A label facestock film according to claim 28, wherein the copolymer is blended with one or more other materials in the skin layer.

34. A label facestock film according to claim 33, wherein the copolymer is blended with a styrenic homopolymer.

35. A label facestock film according to claim 34, wherein the styrenic homopolymer is present in the skin layer in an amount of less than 20% by weight of the coating.

36. A label facestock film according to claim 28, comprising at least one tie constituent having compatibility with the polymeric material of the core layer and with the skin layer, the said compatibility of the tie constituent deterring delamination of the skin layer from the core layer.

37. A label facestock film according to claim 36, wherein the at least one tie constituent is provided in a tie layer of the film between the core layer and the at least one skin layer.

38. A label facestock film according to claim 36, wherein the tie constituent is provided in the core layer.

39. A label facestock film according to claim 36, wherein the tie constituent is provided in the skin layer.

40. A label facestock film according to claim 36, wherein the tie constituent comprises a derivative of styrene-butadiene.

41. A label facestock film according to claim 40, wherein the tie constituent comprises hydrogenated styrene-butadiene.

42. A label facestock film according to claim 28, wherein the core layer and the skin layer are co-extruded.

43. A label facestock film according to claim 28, wherein the skin layer is provided on the core layer by means of melt coat extrusion.

44. A label facestock film according to claim 28, which when printed with ink on the skin layer will not shed more than 30% of the ink when subjected to a standard ink pull-off test.

45. A label facestock film according to claim 28, further comprising one or more additional materials selected from anti-block additives, opacifiers, fillers, UV absorbers, cross-linkers, colorants, anti-static agents, antioxidants, anti-haze agents, slip additives and combinations of two or more thereof.

46. A label facestock film according to claim 28, further treated to improve ink receptivity of the skin layer.

47. A label facestock film according to claim 46, wherein the further treatment comprises corona discharge treatment.

48. A label facestock film according to claim 28, having a thickness of from about 40 to about 240 μm.

49. A label facestock film according to claim 28, printed on the skin layer with at least one ink.

50. A label made from a facestock in accordance with claim 28.

51. A labelstock film for adhesive labels which comprises:
an inherently ink printable multi-layer facestock film having a substrate core layer comprising a polymeric material and at least one skin layer which is ink printable, the ink printable skin layer comprising: a copolymer of styrene and butadiene; and polystyrene in an amount of from 0% to about 30% by weight of the skin layer; and
an adhesive layer provided on the facestock.

52. A labelstock film according to claim 51, wherein the adhesive layer is a pressure-sensitive adhesive layer.

53. A labelstock film according to claim 51, further comprising a release coated liner in contact with and releasably joined to the adhesive layer.

54. An adhesive label die-cut from the labelstock of claim 53.
